(19) United States
(12) Patent Application Publication
(10) Pub. No.: US 2018/0133738 A1
(43) Pub. Date: May 17, 2018

(54) COATING METHOD AND COATING DEVICE

(71) Applicant: TOYO SEIKAN CO., LTD., Tokyo (JP)

(72) Inventors: Kouhei Endo, Yokohama-shi (JP); Takuya Mori, Yokohama-shi (JP); Taketoshi Manou, Yokohama-shi (JP); Tomoyuki Miyazaki, Yokohama-shi (JP); Keisuke Nyuu, Yokohama-shi (JP)

(73) Assignee: TOYO SEIKAN CO., LTD., Tokyo (JP)

(21) Appl. No.: 15/868,077

(22) Filed: Jan. 11, 2018

Related U.S. Application Data
(63) Continuation of application No. PCT/JP2016/068490, filed on Jun. 22, 2016.

(30) Foreign Application Priority Data
Jul. 16, 2015 (JP) 2015-142211

(51) Int. Cl. B05B 13/06; B05B 3/02; B05D 7/22; B05D 1/02; B05D 1/00

(52) U.S. Cl. CPC B05B 13/0636; B05B 3/02; B05D 1/002; B05D 1/02; B05D 7/227

(57) ABSTRACT

Provided are a coating method and a coating device capable of making the coating film thickness of a coating agent uniform with a simple structure. Provided is a coating method, the coating; method including moving a spray gun (20) and the container (C) relative to each other to insert the spray gun (20) into the container (C), and ejecting the coating agent onto the container inner wall surface from the spray gun while adjusting a relative positional relationship between the spray gun (20) and the container (C) in the gun longitudinal direction, rotating the spray gun (20) and the container (C) relative to each other about an axis along the gun longitudinal direction, and changing at least one of a relative rotation speed between the spray gun (20) and the container (C) and an angle range of the rotation in accordance with the shape of the container (C).

### TECHNICAL FIELD

The present invention relates to a coating method and a coating device for coating a container inner wall surface with a coating agent, and in particular relates to a coating method and a coating device for coating the container inner wall surface with a coating agent that improves slidability.

### BACKGROUND ART

In general, a plastic container is easy to form and can be manufactured inexpensively, and hence the plastic container is used widely for various purposes. However, in the case where viscous contents such as a mayonnaise-like food are injected into the container, the contents easily adhere to a container inner wall surface, and hence there has been a problem that it is difficult to use up the contents without leaving the contents in the container. To cope with this, development of a coating agent that improves slidability of the contents is promoted in recent years and, it is known that, in the case where the container inner wall surface is coated with such a coating agent, the slidability of the container inner wall surface is improved, and the contents in the container can be easily used up.

In order to exert the performance of such a coating agent adequately, it is necessary to uniformly coat the container inner wall surface with the coating agent. However, the shape of the plastic container varies widely and the diameter of the opening of the plastic container is small, and hence there has been a problem that, in the case where a commonly used spray gun (see, e.g., Patent Literature 1) is used as a coating device, it is difficult to uniformly coat the container inner wall surface with the coating agent.

To cope with this, in Japanese Patent Application No. 2014-87331, the applicant has proposed, as the coating device that solves the above problem, the coating device including a spray gun that has a spray nozzle capable of electing the coating agent, a rotary driver for rotating the spray gun about an axis along a gun longitudinal direction, and a mover for moving the spray gun along the gun longitudinal direction.

In the coating device described in Japanese Patent Application No. 2014-87331, the entire container inner wall surface is coated with the coating agent by inserting the spray gun into the container, and ejecting the coating agent from the spray nozzle while rotating the spray gun about the axis along the gun longitudinal direction and, at the same time, moving the spray gun up and down or back and forth.

### CITATION LIST

### Patent Literature

Patent Literature 1: Japanese Patent Application Publication No. 2001-224988

### SUMMARY OF INVENTION

### Technical Problem

In the case where the container inner wall surface is coated with, the above-described coating agent that improves the slidability of the contents, when the coating film thickness of the coating agent becomes uneven, the slidability of the container inner wail surface is reduced. Accordingly, required accuracy in the uniformity of the coating film thickness of the coating agent is high.

In this regard, the coating device described in Japanese Patent Application No. 2014-87331 is capable of coating the entire container inner wall surface with the coating agent but, in the case where a container having a special shape such as a mayonnaise bottle in which the diameter of a body on the side of an opening is small is a coating target, the coating device has a problem that the coating film thickness of the coating agent on the container inner wall surface becomes uneven. That is, in the coating device, the ejection amount of the coating agent from the spray nozzle per unit time is constant and, in the case where the container such as the mayonnaise bottle in which a distance from the position of the spray nozzle to the container inner wall surface is not uniform is the coating target, the coating film thickness of the coating agent becomes uneven depending on the area of the container inner wall surface.

To cope with this, the present invention solves these problems, and an object thereof is to provide a coating method and the coating device capable of making the coating film thickness of the coating agent uniform with a simple structure even in the case where the container having the special shape is the coating target.

### Solution to Problem

A coating method of the present invention is a coating method for coating, a container inner wall surface with a coating agent, the coating method including moving a spray gun that ejects the coating agent and a container relative to each other along a gun longitudinal direction to insert the spray gun into the container, and ejecting the coating agent onto the container inner wall surface from the spray gun while adjusting a relative positional relationship between the spray gun and the container in the gun longitudinal direction, rotating the spray gun and the container relative to each other about an axis along the gun longitudinal direction, and changing at least one of a relative rotation speed between the spray gun and the container and an angle range of the rotation in accordance with a shape of the container, whereby the above problems are solved.

In addition, a coating device of the present invention is a coating device for coating a container inner wall surface with a coating agent, the coating device including a spray gun that ejects the coating agent, a rotary driver that rotates the spray gun about an axis along a gun longitudinal direction, and a mover that moves the spray gun along the gun longitudinal direction, wherein the rotary driver has a rotation control section that changes at least one of a rotation speed and a rotation angle range of the spray gun, whereby the above problems are solved.

### Advantageous Effects of Invention

According to first, second, third, sixth, and seventh aspects of the present invention, it is possible to make the coating film thickness of the coating agent uniform with a simple structure even in the case where the container having a special shape is a coating target by changing at least one of the relative rotation speed between the spray gun and the container and the angle range of the rotation in accordance with the shape of the container, i.e., a distance from the position of a spray nozzle to the container inner wall surface when the coating agent is ejected from the spray gun.

In addition, in the case where a configuration is adopted in which the container is held so as not to rotate and the spray gun is rotated, it is not necessary to install a rotation device of the container in an existing manufacturing line, it is possible to efficiently perform the coating of the coating agent in limited space in the manufacturing line, and it is easy to reliably hold the container even in the case where the container has the special shape.

According to fourth and eighth aspects of the present invention, it is possible to make the coating film thickness of the coating agent uniform with the simple structure even in the case where the container having a special shape such as a mayonnaise bottle in which a cross-sectional shape changes along a container height direction is the coating target by changing at least one of the relative rotation speed between the spray gun and the container and the angle range of the rotation at each set position at which the spray gun is stopped by moving the spray gun intermittently such that the spray gun is stopped at a plurality of the set positions in the gun longitudinal direction.

According to fifth and ninth aspects of the present invention, it is possible to prevent an atomized coating agent from adhering to unplanned portions such as the upper end edge of a container mouth, the spray nozzle, and an external environment, and make the coating film thickness of the coating agent uniform by causing an aspirator to face the container mouth and suck the coating agent atomized in the container during or after the ejection of the coating agent from the spray gun.

### BRIEF DESCRIPTION OF DRAWINGS

FIG. 1 is a front view showing a coating device according to Embodiment 1 of the present invention.

FIG. 2 is a side view showing the coating device.

FIG. 3 is an explanatory view showing the flow of a coating agent.

FIG. 4 is an explanatory view showing an aspirator incorporated in the coating device according to Embodiment 2 of the present invention.

FIG. 5 is an explanatory view showing a modification of the aspirator.

### REFERENCE SIGNS LIST

10 Coating device

20 Spray gun

21 Shaft

22 Spray nozzle

23 Coating agent ejection path

24 Coating agent passage

30 Outward pipe

31 Coating agent passage

32 Elastic shape section

33 Return pipe

34 Coating agent passage

35 Elastic shape section

40 Coating agent circulation path

50 supply controller

51 Valve

52 Air supply pipe

60 rotary driver

61 Stepping motor (rotation control section)

62 Motor coupling

70 mover

71 Moving section

72 Base

73 Stepping motor (position control section)

80 Rotation supporter

81 Bearing

90 Container holder

100 aspirator

101 Air flow amplification flow path section

102 Gas supply section

103 Intake port

104 Ejection port

105 Gas supply pipe

106 Air ejection nozzle

107 Gas suction pipe

C Container

C1 Container mouth

L Coating agent

A Air

### Description of Embodiments

Hereinbelow, a coating device 10 according to Embodiment 1 of the present invention will be described based on the drawings.

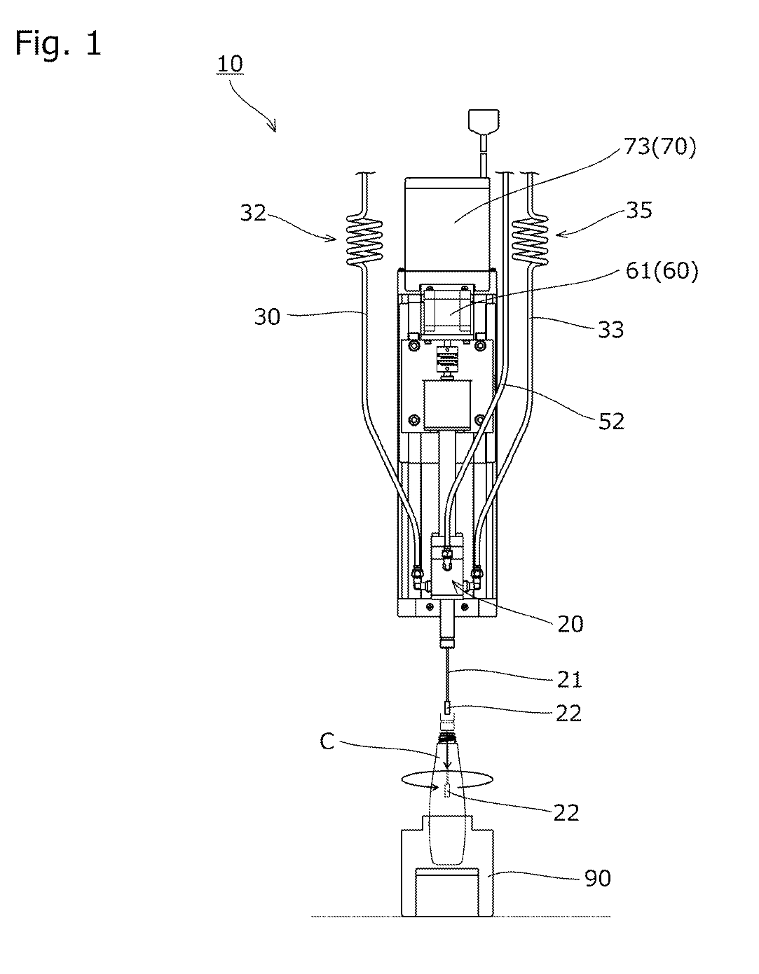

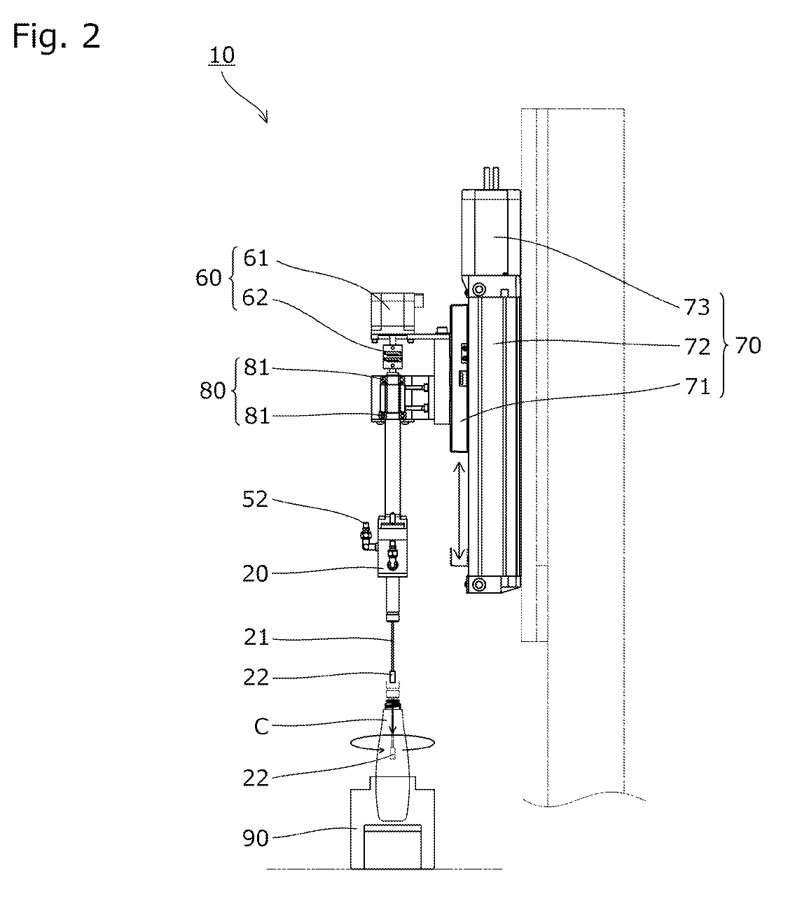

As shown in FIGS. 1 and 2, the coating device 10 coats the inner wall surface of a container C that contains viscous contents such as a mayonnaise-like food with a coating agent L that improves slidability of the contents by inserting a spray nozzle 22 into the container C first, and ejecting the coating agent L from the spray nozzle 22 while rotating a spray gun 20 in the container C.

As shown in FIGS. 1 to 3, the coating device 10 includes the spray gun 20 that has a coating agent ejection path 23, an outward pipe 30 and a return pipe 33 that are mounted to the spray gun 20 and constitute a coating agent circulation path 40, a supply controller 50 for controlling the supply of the coating agent L to the coating agent ejection path 23 from the coating agent circulation path 40, a rotary driver 60 for rotating the spray gun 20 about an axis along a gun longitudinal direction, a mover 70 for moving the spray gun 20 along the gun longitudinal direction, a rotation supporter 80 that has bearings 81 that rotatably support the spray gun 20, and a container holder 90 for holding the container C.

Hereinbelow, each component of the coating device 10 will be described based on FIGS. 1 to 3.

First, as shown in FIGS. 1 to 3, the spray gun 20 ejects the coating agent L, and has a shaft 21 that can be inserted into the container C, and the spray nozzle 22 that is provided at the tip of the shaft 21. Herein, the nozzle shape of the spray nozzle 22 may be any shape as long as the nozzle shape causes the spray nozzle 22 to eject the coating agent L such that the coating agent L is spread, and the nozzle shape that causes the spray nozzle 22 to eject the coating agent L such that the coating agent L is spread symmetrically is preferable. In addition, one spray nozzle 22 is provided at the tip of the shaft 21 in the present embodiment, but the number of spray nozzles 22 and the position of the spray nozzle 22 may be any number and any position, and an air ejection port maybe provided in the spray nozzle 22 in order to atomize the coating agent L ejected from the spray nozzle 22.

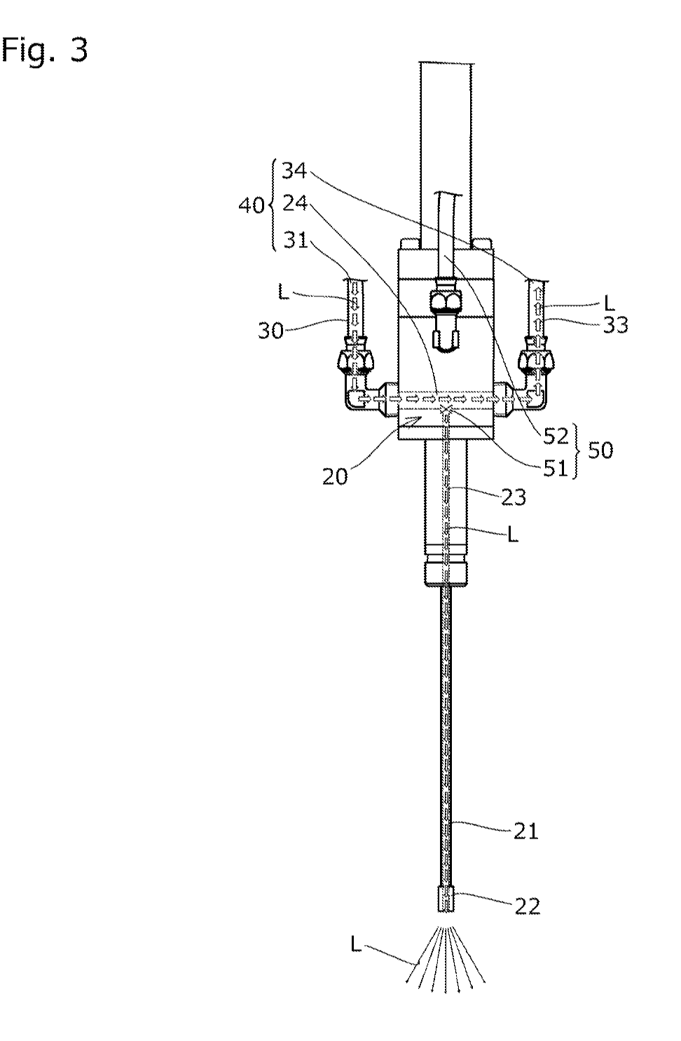

As shown in FIG. 3, inside the spray gun 20, the coating agent ejection path 23 that communicates with the spray nozzle 22, and a coating agent passage 24 that communicates with the coating agent ejection path 23 are formed. The coating agent passage 24 constitutes the coating agent circulation path 40 that circulates the coating agent L together with a coating agent passage 31 in the outward pipe 30 and a coating agent passage 34 in the return pipe 33.

As shown in FIG. 1, the outward pipe 30 and the return pipe 33 are disposed outside the spray gun 20, one end of each of the outward pipe 30 and the return pipe 33 is mounted to the outer peripheral surface of the spray gun 20, and the other end thereof is mounted to a tank (not shown) in which the coating agent L is stored. The outward pipe 30 and the return pipe 33 are formed of hard synthetic resin such as high-density polyethylene so as to bear the pressure of the coating agent L that circulates in the coating agent passages 31 and 34 formed inside the outward pipe 30 and the return pipe 33. As shown in FIG. 1, in the outward pipe 30 and the return pipe 33, coil-shaped elastic shape sections 32 and 35 are formed.

As can be seen from FIG. 3, the supply controller 50 has a valve 51 that is provided between the coating agent ejection path 23 and the coating agent circulation path 40 and can be opened and closed, an air supply pipe 52 that constitutes air ejection means for supplying air for opening and closing the valve 51, and an air supply source (not shown) that is connected to the air supply pipe 52. The valve 51 is opened by supplying air to the spray gun 20 through the air supply pipe 52, and the coating agent L is supplied to the coating agent ejection path 23 from the coating agent circulation path 40 by using the pressure of the coating agent L in the coating agent circulation path 40. Thus, in the present embodiment, the ejection timing and the ejection amount of the coating agent L from the spray nozzle 22 are controlled by the timing and the time of the air supply.

Note that the specific configuration of the supply controller 50 may be any configuration as long as the configuration controls the supply of the coating agent L to the coating agent ejection path 23 from the coating agent circulation path 40, and the drive source of the supply controller 50 may also be any drive source such as a drive source that uses electric power, in addition to the above-described drive source that uses air.

As shown in FIG. 2, the rotary driver 60 has a stepping motor 61 that rotationally drives the spray gun 20, and a motor coupling 62 that couples the output shaft of the stepping motor 61 to the upper end of the spray gun 20.

The stepping motor 61 is controlled by a PLC or the like, and its rotation speed and rotation angle range can be set arbitrarily. In the present embodiment, the stepping motor 61 functions as a rotation control section capable of changing at least one of the rotation speed and the rotation angle range of the spray gun 20.

Note that the specific configuration of the rotation control section is not limited to the above-described stepping motor, and the specific configuration thereof may be any configuration as long as the configuration is capable of changing at least one of the rotation speed and the rotation angle range of the spray gun 20. For example, a servo motor may be used instead of the stepping motor

61, and the rotation speed may be controlled by connecting a speed controller capable of controlling the flow rate of supplied air to an air rotary actuator.

As shown in. FIG. 2, the mover 70 is constituted by a moving section 71 that is movable along an up-and-down direction, a base 72 that supports the moving section 71 such that the moving section 71 is movable in the up-and-down direction, and a stepping motor 73 that drives the moving section 71. The mover 70 moves the moving section 71 in the up-and-down direction by converting the rotation of the stepping motor 73 into linear motion with a ball screw, a rack and pinion, and the like. The stepping motor 61, the rotation supporter 80, and the like are fixed to the moving section 71.

The stepping motor 73 is controlled by the PLC or the like, and its rotation speed, rotation angle range and the like can be set arbitrarily. In the present embodiment, the stepping motor 73 functions as a position control section capable of stopping the spray gun 20 at a plurality of set positions in the gun longitudinal direction.

Note that the specific configuration of the position control section is not limited to the above-described stepping motor, and the specific configuration thereof may be any configuration as long as the configuration is capable of stopping the spray gun 20 at the plurality of set positions in the gun longitudinal direction. For example, the servomotor may be used instead of the stepping motor 61.

The container holder 90 is provided such that the container bolder 90 is movable in a horizontal direction, is configured to hold the container C in a fixed state, and is used also in other steps of a container manufacturing line. Note that the specific configuration of the container holder 90 may be any configuration as long as the configuration is capable of holding the container C.

Next, hereinbelow, a description will be given of one example of a coating method of the coating agent L that uses the coating device 10 in the present embodiment.

First, after the container C serving as a coating target is moved to a position below the spray gun 20, the spray gun 20 is moved downward, and the shaft 21 is inserted into the container

Next, after the spray gun 20 is stopped at the set position, the spray gun 20 is rotated 180° at any rotation speed and, at the same time, the coating agent L is ejected from the spray nozzle 22.

Next, after the spray gun 20 is moved upward and stopped at the next set position, the spray gun 20 is rotated 180° at any rotation speed and, at the same time, the coating agent L is ejected from the spray nozzle 22.

Thereafter, the entire inner wall surface of the container C is coated with the coating agent L by repeating the rise and the stop of the spray gun 20, and the rotation of the spray gun 20 and the ejection of the coating agent L while changing the rotation speed of the spray gun 20 at each set position in accordance with the shape and the size of the container C.

Note that the above-described embodiment is one example of the operation of the coating device 10 of the present invention, and the coating device. 10 is installed in the up-and-down direction. However, the coating device 10 only needs to be installed in the gun longitudinal direction, such as the case where the coating device 10 is installed in the horizontal direction, and the installation mode of the coating device 10 may be any installation mode.

In addition, the number of movements (the number of rises/the number of stops) of the spray gun 20, the rotation speed of the spray gun 20 at each set position, the ejection amount of the coating agent L, and the speed of each of the descent and the rise of the spray gun 20 may be determined arbitrarily in accordance with the shape and the size of the container C.

In addition, in the above description, the description has been made on the assumption that the rotation speed of the spray gun 20 is changed from one set position to another by the rotation control section (the stepping motor 61). However, the rotation angle range of the spray gun 20 may be changed front one set position to another by the rotation control section, such as the case where the spray gun 20 is rotated 180° at one set position and is rotated 360° at another set position. Further, both of the rotation speed and the rotation angle range of the spray gun 20 may be changed from one set position to another by the rotation control section.

Furthermore, in the above description, the description has been made on the assumption that the spray gun 20 is rotated at a constant speed at one set position, but the rotation speed of the spray gun 20 may be changed during the rotation of the spray gun. 20 at one set position.

In addition, in the above description, the description has been made on the assumption that the coating agent L is ejected while the spray gun 20 is rotated in the state in which the spray gun 20 is stopped at each set position, but the spray gun 20 may be rotated and the coating agent L may be ejected while the spray gun 20 is moved, in the gun longitudinal direction without being stopped.

Further, in the above-described embodiment, the configuration is adopted in which the spray gun 20 is rotated about the axis along the gun longitudinal direction and the container holder 90 is not rotated. However, a configuration may be adopted in which the spray gun 20 is not rotated and the container holder 90 is rotated and, further, a configuration may also be adopted in which both of the spray gun 20 and the container holder 90 are rotated. In the case where the configuration is adopted in which the container holder 90 is rotated, the container holder 90 may be appropriately driven rotationally by a mechanism similar to the above-described rotary driver 60.

In addition, in the above-described embodiment, the configuration is adopted in which the spray gun 20 is moved in the gun longitudinal direction and the container holder 90 is not moved. However, a configuration may be adopted in which the spray gun 20 is not moved and the container holder 90 is moved and, farther, a configuration may also be adopted in which both of the spray gun 20 and the container holder 90 are moved. In the case where the configuration is adopted in which the container holder 90 is moved, the container holder 90 may be appropriately moved by a mechanism similar to the above-described mover 70.

Further, the description has been made on the assumption that the coating agent L applied to the container C improves the slidability of contents, and the container C is the container which is filled with viscous contents such as a mayonnaise-like food and in which the viscous contents are sealed, but the specific type of the coating agent L and the use of the container C may be any type and any use.

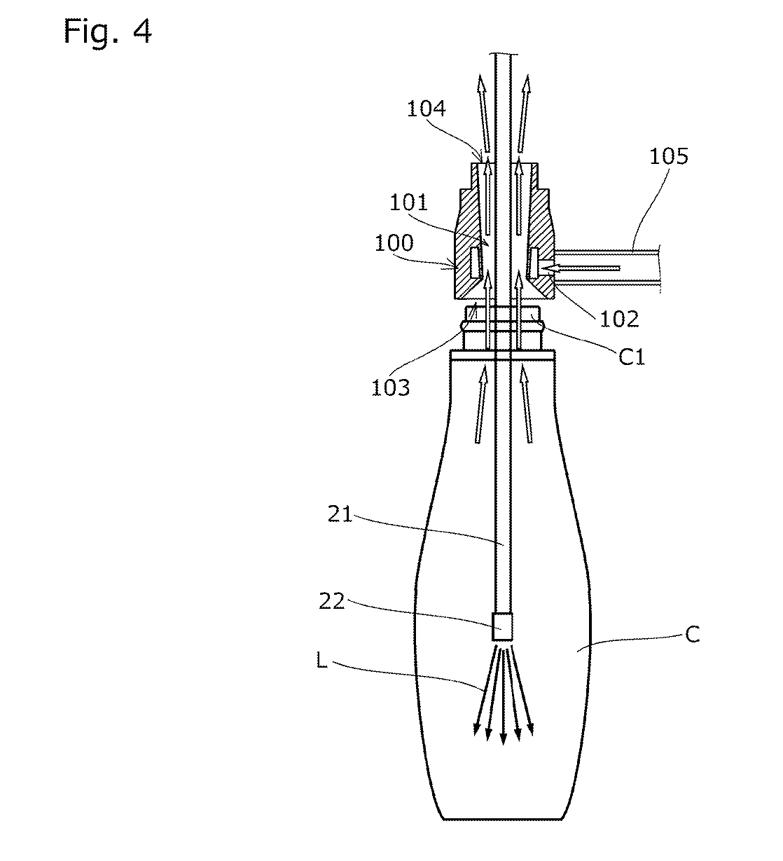

Next, the coating device 10 according to Embodiment 2of the present invention will be described based on FIG. 4. Herein, the configuration of Embodiment 2 is exactly the same as that of Embodiment 1 described above except part of the configuration, and hence the description of the configuration other than differences will be omitted.

In the above-described coating device 10, there is a possibility that, when the inside of the container C is coated with the coating agent L, the coating agent L ejected from the spray nozzle 22 is atomized in the container C, and the atomized coating agent L adheres to the upper end edge of a container mouth C1 and bonding of a seal member to the upper end edge of the container mouth C1 is thereby adversely affected, or the atomized coating agent L adheres to the spray nozzle 22 and the ejection of the coating agent L from the spray nozzle 22 is thereby adversely affected. In addition, external environment contamination is caused by curling up of the coating agent L atomized in the container C and, further, deformation of the: container C occurs due to an increase in internal pressure, and it becomes difficult to strike a balance between the coating speed of the coating agent L to the inner wall surface of the container C and uniform coating. To cope with this, in the coating device 10 in Embodiment 2, in order to prevent the occurrence of the above-described situations, an aspirator 100 capable of facing the longitudinal direction of the container mouth C1(an upper side in an example shown in the drawing) is provided. Note that, although not shown in the drawing, a suction duct or the like is provided on or in the vicinity of the aspirator 100 as a countermeasure against the external environment contamination.

The aspirator 100 is formed into a substantially cylindrical shape, includes, as shown in FIG. 4, a gas supply section 102 that is connected to an air supply source (not shown) with a gas supply pipe 105 and an air flow amplification flow path section 101 that has a lower intake port 103 and an upper ejection port 104, and has the function of an amplification mechanism described in Japanese Patent Application Publication No. H04-184000 or Japanese Patent Application Publication No. 2006-291941.

Specifically, the aspirator 100 is disposed such that the shaft 21 of the spray gun 20 is positioned in the air flow amplification flow path section 101 in the gun longitudinal direction, or the up-and-down:direction in an example-shown in the drawing, and ejects gas such as air supplied to the gas supply section 102 toward the ejection port 104 along the inner periphery of the air flow amplification flow path section 101 at high speed. The aspirator 100 is configured to suck gas including the coating agent L atomized in the container C from the intake port 103 disposed to face the upper side of the container mouth C1 by the ejection of the gas, and eject the high-speed and high-pressure gas from the ejection port 104.

In addition, the aspirator 100 is configured to be movable along the up-and-down direction independently of the movement of the spray gun 20 along the gun longitudinal direction, or the up-and-down direction in the example shown in the drawing. Note that the aspirator 100 may also be disposed in a fixed manner such that the aspirator 100 is not movable in the up-and-down direction.

Next, hereinbelow, a description will be given of an example of the operation of the coating device 10 in Embodiment 2. Note that the coating method of the coating agent L that uses the spray gun 20 and the like is similar to that in Embodiment 1, and hence the detailed description thereof will be omitted.

First, after the container C serving as the coating target, is moved to the position below the spray gun 20, the shaft 21 of the spray gun 20 is inserted into the container C and, at the same time, the aspirator 100 is moved downward and is stopped at a position where the intake port 103 of the air flow amplification flow path section 101 maintains a slight distance between the intake port 103 and the container mouth C1.

Note that the distance between the intake port 103 and the container mouth C1 is preferably as short as possible in a range that does not allow the container C itself to deform or adhere to the intake port 103 due to negative pressure resulting from the suction of the gas in the container C by the aspirator 100.

Next, the coating agent L is ejected from the spray nozzle 22 while the aspirator 100 sucks the gas in the container C by supplying gas such as air to the gas supply section 102, and the inner wall surface of the container C is coated with the coating agent L.

Note that the above-described operation in the embodiment is one example of the operation of the coating device 10 of the present invention, and the timing of the movement of the aspirator 100 to the position in the vicinity of the container mouth C and the timing of the suction of the gas in the container C may be determined arbitrarily.

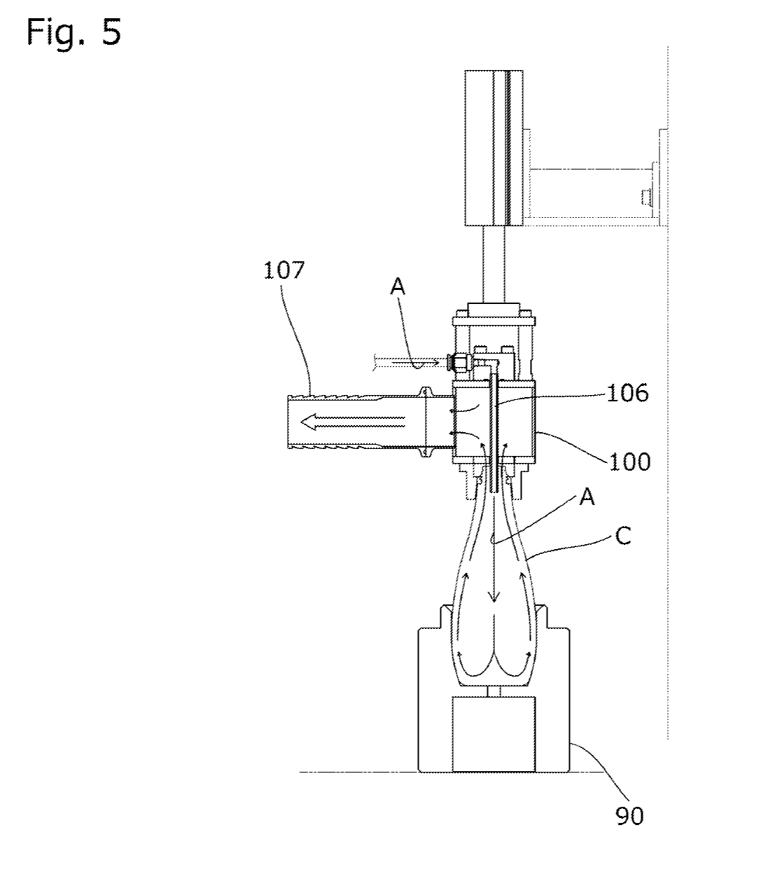

Next, a modification of the aspirator 100 will be described based on FIG. 5.

The description has been made on the assumption that the above-described aspirator 100 shown in FIG. 4 sucks the coating agent L atomized in the container C during the ejection of the coating agent L from the spray nozzle 22.

In contrast to this, the aspirator 100 of the modification shown in FIG. 5 sucks the coating agent L atomized in the container C after the inner wall surface of the container C is coated with the coating agent L by the coating device 10 in another step in the device of the coating device 10 or after being installed downstream of the coating device 10 in the container manufacturing line.

In addition, the aspirator 100 shown in FIG. 5 includes an air ejection nozzle 106 that is provided such that the air ejection nozzle 106 is movable along the up-and-down direction, and is inserted into the container C in a state in which the aspirator 100 is disposed to face the upper side of the container mouth C1, and air A is ejected from the air ejection nozzle 106 when the coating agent L is sucked by the aspirator 100.

Further, a gas suction pipe 107 is connected to the aspirator 100 shown in FIG. 5, and the aspirator 100 sucks gas including the coating agent L atomized in the container C by sucking gas in the container C and the aspirator 100 from the gas suction pipe 107.

Note that the specific configuration of the suction mechanism may also be a configuration that uses a principle other than the principle described above as long as the configuration is capable of sucking the gas from the container mouth C1.

1. A coating method for coating a container inner wall surface with a coating agent, the coating method comprising:
moving a spray gun that ejects the coating agent and a container relative to each other along a gun longitudinal direction to insert the spray gun into the container; and
ejecting the coating agent onto the container inner wall surface from the spray gun while adjusting a relative positional relationship between the spray gun and the container in the gun longitudinal direction, rotating the spray gun and the container relative to each other about an axis along the gun longitudinal direction, and changing at least one of a relative rotation speed between the spray gun and the container and an angle range of the rotation in accordance with a shape of the container.

2. The coating method according to claim 1, wherein
the container is held so as not to rotate, and
the spray gun is rotated such that the coating agent is ejected from the spray gun.

3. The coating method according to claim 1, further comprising changing the relative rotation speed between the spray gun and the container.

4. The coating method according to claim 1, further comprising moving the spray gun intermittently such that the spray gun is stopped at a plurality of set positions in the gun longitudinal direction.

5. The coating method according to claim 1, further comprising causing an aspirator to face a container mouth and suck the coating agent atomized in the container during or after the ejection of the coating agent from the spray gun.

6. A coating device for coating, a container inner wall surface with a coating agent, the coating device comprising:
a spray gun that ejects the coating agent;
a rotary driver that rotates the spray gun about an axis along a gun longitudinal direction; and
a mover that moves the spray gun along the gun longitudinal direction, wherein
the rotary driver has a rotation control section that changes at least one of a rotation speed and a rotation angle range of the spray gun.

7. The coating device according to claim 6, wherein
the rotation control section is configured to change the rotation speed of the spray gun.

8. The coating device according to claim 6, wherein
the mover has a position control section that stops the spray gun at a plurality of set positions in the gun longitudinal direction.

9. The coating device according to claim 6, further comprising an aspirator capable of facing a container mouth.
